(19) United States
(12) Patent Application Publication
(10) Pub. No.: US 2026/0149685 A1
(43) Pub. Date: May 28, 2026

(54) OMNICHANNEL COMMUNICATION WITH CHANNEL SELECTION

(71) Applicant: Twilio Inc., San Fancisco, CA (US)

(72) Inventors: Stanley Carl Lemon, San Francisco, CA (US); Andrés Felipe Benavides Montoya, San Francisco, CA (US); Antoine Gosselin, San Francisco, CA (US); David Moses Lee, San Francisco, CA (US); Igor Pletnjov, San Francisco, CA (US); Jermaine Chan, San Francisco, CA (US); Matteo Agius-D'Arrigo, San Francisco, CA (US); Sumit Dhungel, San Francisco, CA (US)

(21) Appl. No.: 19/175,837

(22) Filed: Apr. 10, 2025

Related U.S. Application Data
(60) Provisional application No. 63/724,734, filed on Nov. 25, 2024.

(51) Int. Cl. H04L 51/234; H04L 51/226; H04L 67/306

(52) U.S. Cl. CPC H04L 51/234; H04L 51/226; H04L 67/306

(57) ABSTRACT

An omni-channel communication request to send communication content to a recipient is received via an application programming interface (API) call. A recipient profile including communication endpoint identifiers associated with the recipient is identified. Each communication endpoint identifier is associated with a respective communication channel. Based on historical user engagement data, a communication channel that is predicted to yield an optimal value of a chosen user engagement metric is selected from among the communication channels. A communication endpoint identifier associated with the communication channel is selected from among the communication endpoint identifiers associated with the recipient. A message including the communication content is then transmitted to the communication endpoint identifier. A set of channel selection rules may be used to select the communication channel in addition to, or instead of, the historical user engagement data.

### CROSS-REFERENCE TO RELATED APPLICATIONS

The present application claims priority to U.S. Provisional patent Application No. 63/724,734, filed Nov. 25, 2024, the entire contents of which is being incorporated herein by reference.

### TECHNICAL FIELD

Aspects and embodiments of the present disclosure relate to communication services platforms, and in particular to selecting communication channels for communication services platforms.

### BACKGROUND

Communication services platforms can offer various messaging services to users, such as tools that enable sending and/or receiving bulk messages or messages targeted to individual recipients.

### BRIEF DESCRIPTION OF DRAWINGS

Various embodiments in accordance with the present disclosure will be described with reference to the drawings, in which:

FIG. 1 is a block diagram of an example system architecture for selecting channels and senders for communication services platforms, in accordance with an embodiment;

FIG. 2 is a schematic diagram illustrating channel selection, in accordance with an embodiment;

FIG. 3 is a block diagram of an example omni-channel communication component, in accordance with some embodiments;

FIG. 4 is a flow diagram of an example method of channel selection, in accordance with an embodiment;

FIGS. 5A and 5B are a flow diagram of an example method of channel selection for communication services platforms, in accordance with an embodiment; and

FIG. 6 is a block diagram illustrating an example computer system, in accordance with an embodiment.

### DETAILED DESCRIPTION

Communication services platforms can offer various messaging services to users, such as tools that enable sending and/or receiving bulk messages or messages targeted to individual recipients. Communication services platforms can support a variety of communication channels. Communications channels can refer to the various communication methods, technologies, and platforms through which another platform enables interactions between clients and their end users. Examples of channels include Short Messaging Service (SMS), Multimedia Messaging Service (MMS), Rich Communication Services (RCS) (including, e.g., RCS Business Messaging (RBM)), voice calls (via PSTN, cellular, VoIP, or similar), video calls, instant messaging (e.g., WhatsApp, Facebook Messenger), electronic mail, and others. Communication services platforms can provide a layer of abstraction that hides the nuances of each of these channels and provides a uniform interface to users. Customers (e.g., users) of a communication services platform can use the communication services platform to engage with their end users through the platform's messaging tools without having to understand the details of each underlying channel.

A communication services platform can face challenges related to selecting an optimal channel to deliver a message to a specified recipient and foster the recipient engagement. Manual selection of communication channels or rule-based systems may not adapt to individual recipient behaviors. Such methods fail to account for the dynamic nature of user engagement patterns, which can vary based on time of day, message type, device availability, and numerous other factors. Furthermore, when delivery failures occur, systems may either abandon the communication attempt entirely or employ rigid communication sequences that do not consider the unique characteristics of individual recipients. As a result of these challenges, customers of communication services platforms can experience difficulty connecting reliably with their end users, and communication services platforms can experience unnecessary technical burdens related to using suboptimal channels or resending undelivered or unconverted messages.

Additionally, compliance with regional regulations governing electronic communications presents another significant challenge for communication services platforms. Different jurisdictions have varying requirements regarding consent, timing restrictions, and content limitations across different communication channels. Organizations operating across multiple regions need to navigate these complex regulatory environments while still attempting to deliver effective communications. Failure to adhere to these regulations can result in legal penalties, damage to reputation, and disruption of communication services. This regulatory complexity further complicates the channel selection process, as the optimal channel for a particular recipient must not only be technically effective but also compliant with regional requirements.

Aspects of the present disclosure addresses these and other challenges by providing a platform that exhibits an omnichannel communication Application Programming Interface (API), which allows a customer of the platform to submit a request for sending a message, such that the request would identify the recipient (e.g., by their name or other alphanumeric identifier) without specifying any particular communication endpoint identifiers (e.g., phone numbers, email addresses, etc.) associated with the recipient. The platform, which has access to the recipient's information, selects a communication channel, examples of which include SMS, MMS, RCS, RBM, voice calls (via PSTN, cellular, VoIP, or similar), video calls, instant messaging (e.g., WhatsApp, Facebook Messenger) and electronic mail. The selected communication channel is expected to optimize end user engagement, which may be measured by an engagement metric that reflects specific action(s) performed by the recipient in response to receiving the message. Some embodiments select a cost-effective channel among several channels that exhibit similar values of the engagement metric for a given recipient. Some embodiments also ensure that the channel is compliant with applicable regional regulations.

The techniques described herein are particularly valuable in time-sensitive scenarios where message delivery is critical, such as account security notifications, service disruption alerts, or important transactional communications. The platform can receive message delivery (or failure) reports from a routing provider, and/or a report from the platform's client indicating that the recipient has performed a certain action (e.g., entered the OTP into the application). In some embodiments, the platform controls the whole OTP process and thus the reports are received from the user verification component of the platform. The platform can use such feedback to determine up-to-date conversion rates for each channel on a granular level (e.g., per destination). The platform can then use the conversion rates to rank channels at a given time and select an optimal channel for delivering specific messages to recipients while filtering available options based on applicable compliance rules. The ability to intelligently select the optimal communication channel and implement effective fallback mechanisms can improve the user engagement while ensuring compliance with regulations and optimizing the costs or adhering to specified cost limits.

Thus, the technical effect includes selecting an optimal channel for a recipient, using message delivery data for making channel decisions, thus increasing message conversion rates, and improving user engagement, as well as improving reliability and reducing costs associated with delivering messages. By continuously updating recipient profiles based on new engagement data and monitoring changes in regulatory requirements, the system can ensure that channel selection algorithms improve over time and adapt to both changing recipient behaviors and evolving compliance landscapes. Unlike communication routing systems that rely on predefined, static rules, this approach can dynamically respond to individual preferences and engagement patterns, significantly improving message delivery success rates while navigating the complex regulatory environments across different regions.

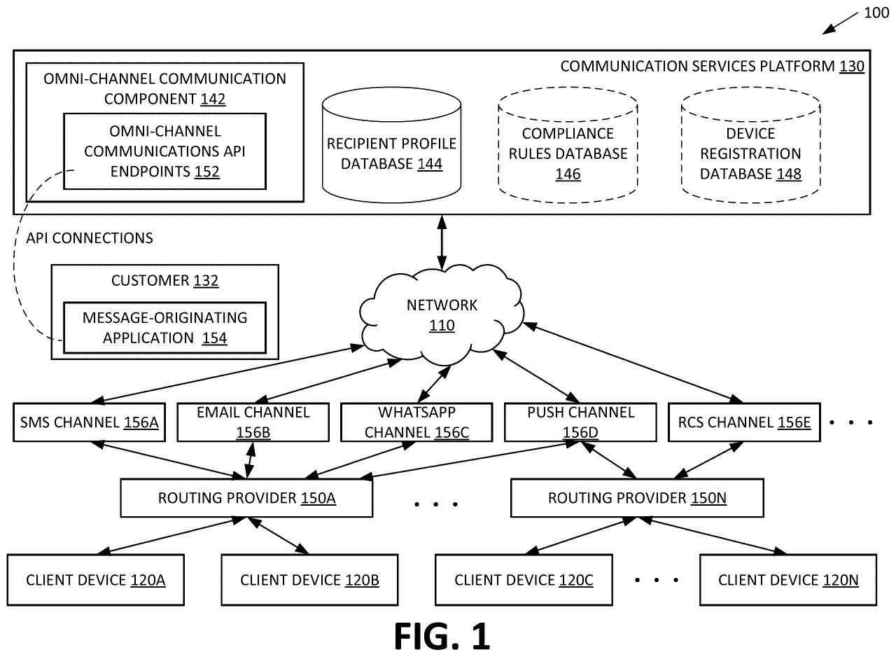

FIG. 1 is a block diagram of an example system architecture 100 for selecting channels and senders for communication services platforms, in accordance with an embodiment. System architecture 100 (also referred to as “system” herein) includes network 110, client devices 120A-N, a communication service platform 130, a customer 132, channels 156A-156N, and routing providers 150A-N. In various embodiments, system 100 can include more or fewer components in different configurations than those depicted in FIG. 1.

Network 110 can include a public network (e.g., the Internet), a private network (e.g., a LAN, a WAN, a VPN, an enterprise network), a wired network (e.g., Ethernet), a wireless network (e.g., an 802.11 Wi-Fi network), a cellular network (e.g., a 5G network), routers, hubs, switches, server computers, or a combination thereof. Network 110 or components thereof can be associated with different organizations in various embodiments. For example, components of network 110 can be associated with Internet Service Providers (ISPs), mobile or cellular carriers, cloud platform or software-as-a-service (SaaS) providers, private or public enterprises, private households, or communities, etc. In some embodiments, network 110 (or a component thereof) can be a physical or virtual interconnect within a single device, such as a PCIe bus, a messaging system, or an API.

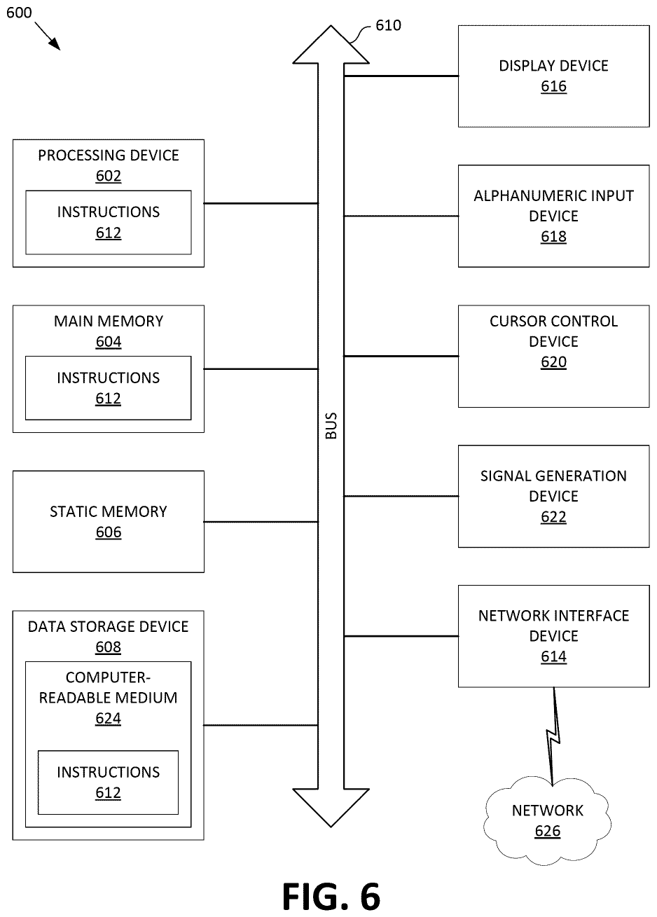

Client devices 120A-N can be personal computers (PCs), laptops, notebook computers, mobile phones, smartphones, tablet computers, digital assistants, network-connected televisions (e.g., smart TVs), or any other computing devices. The computer system of FIG. 6 can be an example of a client device. In various embodiments, client devices 120A-N can also be referred to as “user devices” or “recipient devices.” In some embodiments, a client device of client devices 120A-N can be a destination of a message and can be associated with a destination identifier such as a phone number, a username, and email address, or similar. Client devices 120A-N can run an operating system (OS) that manages hardware and software of the client devices. Client devices 120A-N can further include a web browser, application, or other software for receiving messages. Client devices 120A-N can be used by users such as recipients of messages, who can be end-users of one or more message-originating entities, each of which in turn can be a customer of the communication services platform). In general, and as described below, functions described in embodiments as being performed by a message-originating entity (e.g., a customer of the communication services platform), such as customer 132, and/or communication services platform 130 can also or alternatively be performed on client devices 120A-N in other embodiments. In addition, the functionality attributed to a particular component can be performed by different or multiple components operating together.

Each of communication services platform 130 and customer 132 can be server, such as a rackmount server, a router computer, a personal computer, a portable digital assistant, a mobile phone, a laptop computer, a tablet computer, a netbook, a desktop computer, a virtual machine (VM), etc., or any combination of the above. The computer system of FIG. 6 can be an example of a server. In various embodiments, each of communication services platform 130 and customer 132 can be several computing devices, such as multiple rackmount servers in a data center(s) or multiple VMs in a cloud platform. In some embodiments, functions provided by communication services platform 130 and customer 132 can alternatively be provided by a single server device.

Customer 132 can implement message-originating application 154. Message-originating application 154 can be implemented by a hardware (e.g., circuitry, dedicated logic, etc.) or software (e.g., code, libraries, firmware, etc.) tool of a message-originating entity, such as a customer of the communication services platform 130, that sends messages to destinations and/or recipients, such as client devices 120A-N. The customer can be a person, business, company, and/or any other type of entity that uses system 100 to transmit messages to intended recipients. Message-originating application 154 can send messages to destinations and/or recipients using communication services platform 130. For example, message-originating application 154 can send informational messages (e.g., links to content, promotions), authentication messages (e.g., one-time passcodes, password resets), or other types of messages to client devices 120A-N via communication services platform 130. The customer 132 can use the functionality of system 100 as part of a service provided by the customer 132. The customer 132 may provide various types of services to its end users, such as a banking service, travel service, retail service, and the like. API calls represent the interface through which message-originating application 154 can communicate with communication services platform 130, making function calls to request message delivery services.

Communication services platform 130 includes an omni-channel communication component 142, which may in turn include omni-channel communications API endpoints 152, and a recipient profile database 144. Omni-channel communication refers to a unified approach for transmitting messages across multiple communication channels (e.g., SMS, MMS, RCS, voice calls, instant messaging, and email) where the system intelligently selects the channel that would optimize a chosen channel selection metric (e.g., a recipient engagement metric, a performance metric, a cost-based metric, etc.). This approach enables sending messages to recipients by their identity rather than specific endpoints. In some embodiments, communication services platform 130 can also include a compliance rules database 146 and/or a device registration database 148. Omni-channel communication component 142 can be a hardware or software tool that receives messages addressed to one or more destinations/recipients and sends the messages to their respective destinations/recipients using one or more routing providers. For example, omni-channel communication component 142 can receive a message from message-originating application 154 and can send the received message to one or more of client devices 120A-N using one or more of routing providers 150A-N, via one or more channels 156.

Recipient profile database 144 stores profiles for message recipients, including their communication channel addresses and historical engagement data across different channels. This database supports the platform's ability to optimize channel selection based on recipient behavior patterns. Compliance rules database 146 contains regulatory requirements for different jurisdictions, allowing the system to filter available communication channels based on applicable regional rules regarding consent, timing restrictions, and content limitations. Device registration database 148 can track active devices associated with recipients, enabling precise targeting of specific devices based on recent activity metrics for push notification channels. The recipient profile database 144 can also store custom fields and attributes associated with recipients, which can be utilized for personalization of messages and grouping recipients into audience segments with similar characteristics.

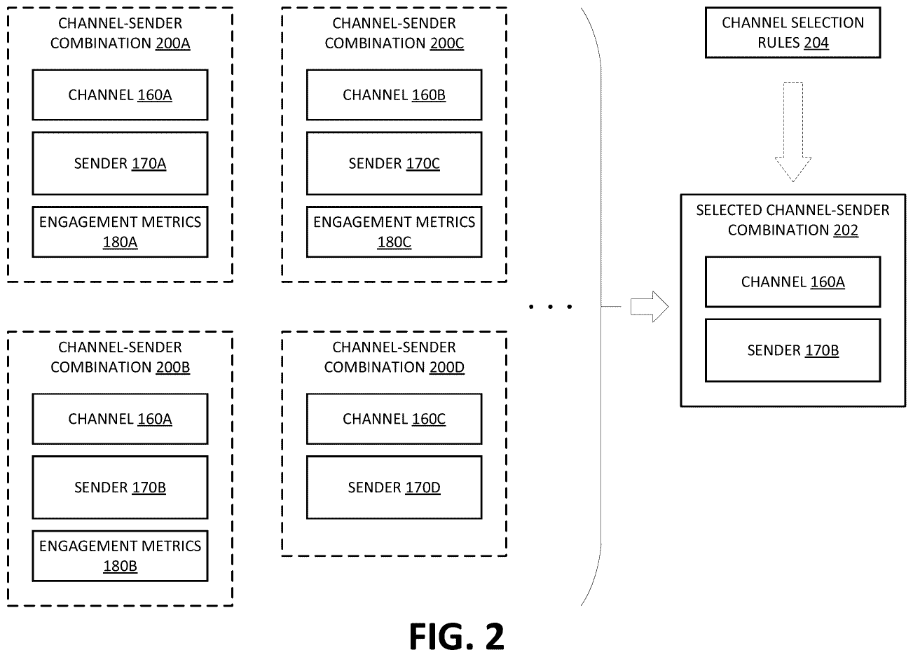

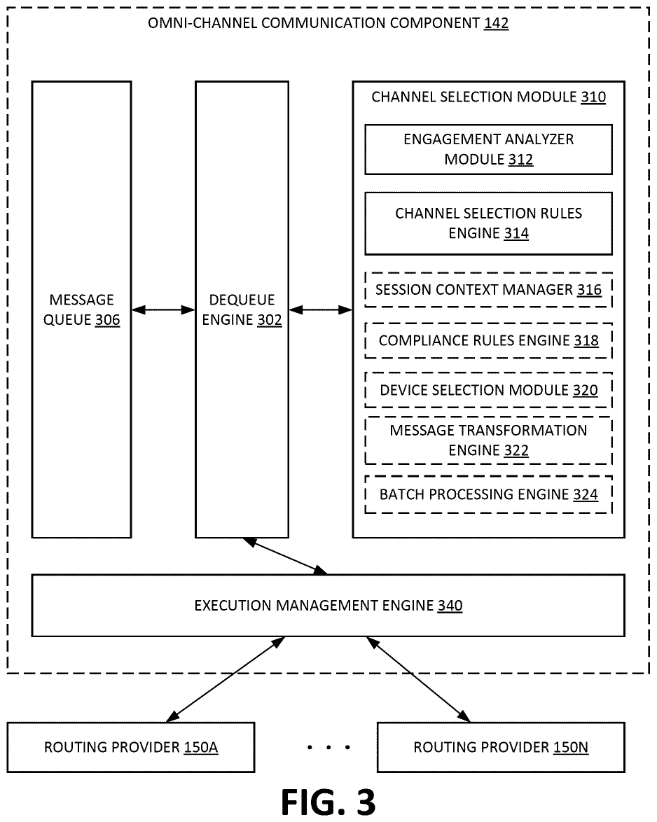

In some embodiments, omni-channel communication component 142 can identify one or more sending options for the destination(s), such as various combinations of communication channels and senders. Examples of senders include an originating phone number (e.g., 10-digit long code or short phone number for SMS), an originating username, an originating email address, a Verified Sender Identity (e.g., for RCS) or similar. Omni-channel communication component 142 can determine one or more metrics for each sending option (e.g., based on feedback data collected from routing providers) and rank the sending options based on the metrics. For example, omni-channel communication component 142 can rank sending options based on message conversion rates, message delivery costs, etc. Omni-channel communication component 142 can select a sending option having an optimal ranking (e.g., highest ranking, lowest ranking, ranking exceeding a threshold value) for sending the message, such as a sending option having the highest conversion rate or lowest maximum message delivery cost. Sending options are further described with reference to FIG. 2. An example omni-channel communication component is further described with reference to FIG. 3.

Routing providers 150A-N can each be an entity for routing messages to recipients. Examples of routing providers include telecommunication providers (e.g., cellular carriers), instant messaging platforms, email providers, and others. Each of routing providers 150A-N can be associated with a physical or virtual destination, such as a geographic region, a Mobile Country Code (MCC)/Mobile Network Code (MNC) tuple, a domain name, or similar.

Message-originating application 154 can communicate with omni-channel communication component 142 using one or more function calls, such as application programming interface (API) function calls (also referred to as “API calls” herein). For example, the one or more function calls can be identified in a request using one or more application layer protocols, such a HyperText Transfer Protocol (HTTP) (or HTTP secure (HTTPS)), and that are sent to omni-channel communication component 142 from message-originating application 154. In some embodiments, omni-channel communication component 142 can respond to the requests from message-originating application 154 by using one or more API responses using an application layer protocol. Similarly, omni-channel communication component 142 can communicate with one or more of routing providers 150A-N using API function calls. Examples of APIs that can be used include a REST (Representational State Transfer) API, a GraphQL API, or a SOAP (Simple Object Access Protocol) API, among others. Omni-channel communication component 142 can include API endpoints 152 that receive and process API calls from message-originating application 154. API connections are established between communication services platform 130 and customer 132, facilitating the communication between message-originating application 154 and omni-channel communication component 142 through API calls and API endpoints 152. These connections enable the message-originating entity to request message delivery services and receive status updates about message transmission and recipient engagement.

Channels 156 represent the various communication methods available for message delivery. These can include, for example, SMS channel 156A for text messaging, email channel 156B for electronic mail communications, WhatsApp channel 156C for instant messaging, push channel 156D for application notifications, RCS channel 156E for rich communication services, and potentially other channels (e.g., MMS, voice calls, video calls, instant messaging applications). The omni-channel communication component 142 can select the optimal channel for each message based on recipient profiles, historical engagement data, and/or compliance requirements.

This architecture enables the intelligent routing of messages by analyzing recipient-specific engagement data, complying with regional regulations, and/or implementing effective fallback mechanisms when delivery failures occur. By leveraging the databases (recipient profiles, compliance rules, and device registration) and the flexible API framework, the system can dynamically adapt to changing recipient behaviors and preferences, improving message delivery success rates while optimizing resource utilization.

In some embodiments, omni-channel communication component 142 can implement a batch processing mechanism that optimizes the sending of same or similar messages to large numbers of recipients. For example, the system may support sending identical or personalized messages to, e.g., thousands of recipients per API call. For even larger campaigns, the system can define audience segments of e.g., millions of recipients based on stored recipient profiles, allowing for efficient bulk messaging while maintaining personalization capabilities. The batch processing mechanism may be channel-optimized and/or use placeholders that are filled in (for each recipient or a subgroup of recipients), like multicast mode.

In situations in which the systems discussed here collect personal information about users, or may make use of personal information, the users can be provided with an opportunity to control whether message-originating application 154, omni-channel communication component 142, and/or routing providers 150A-N collect user information, or to control whether and/or how to receive content from the above components that may be more relevant to the user. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the above components.

FIG. 2 is a schematic diagram illustrating channel selection, in accordance with an embodiment. The example shows channel-sender combinations 200A, 200B, 200C and 200D. Each channel-sender combination includes a channel. Channels 160A-C can each be a mode of communication or a messaging technology for communicating information between message originating entities and message recipients. Examples of channels can include Short Messaging Service (SMS), Multimedia Messaging Service (MMS), Rich Communication Services (RCS) (including, e.g., RCS Business Messaging or RBM), voice calls (via PSTN, cellular, VoIP, or similar), video calls, instant messaging (e.g., WhatsApp), email, and others. Channels can be synchronous (e.g., voice, video) and/or asynchronous (e.g., SMS, email). Channels can be used to transmit messages over shared media such as network 110 or dedicated media such as a Public Switched Telephone Network (PSTN). Different channels can be associated with other shared or distinguishing characteristics not described herein.

Each channel is associated with one or more senders. In the example shown in FIG. 2, the channel 160A is associated with a sender 170A and a sender 170B, whereas the channel 160B is associated with only one sender 170C and the channel 160C is associated with only one sender 170D. Senders 170A-D can each be an identifier of a communication endpoint used by a communication services platform to send a message. Examples of senders include an originating phone number (e.g., 10-digit long code or short phone number for SMS), an originating username, an originating email address, a Verified Sender Identity (e.g., for RCS) or similar. In some embodiments, a message sent using one of senders 170A-D can be routed to a destination or recipient using one of routing providers 150A-N.

In some embodiments, senders 170A-D can be organized into sender pools, which are groups of senders that can be used collectively to increase throughput or enable mixed channel messaging. A sender pool may contain senders from multiple channels (e.g., SMS numbers, WhatsApp business accounts, and RCS agents), allowing the system to select the optimal sender from the pool based on message requirements, recipient preferences, and current performance metrics. Each message is sent using a sender, which may be selected from a pool. The sender pool can be customer-specific, customer-owned, or provided by the communication services platform. The system can automatically attempt delivery using the highest fidelity channel available for each recipient, with automatic fallback to alternative channels when necessary.

In some embodiments, each routing provider and/or channel can exhibit varying levels of performance. For example, the likelihood that a message will be successfully delivered to or engaged with by the recipient can vary among the routing providers and channels. Further, the performance of each sender and/or channel can vary over time. Senders using multiple channels (e.g., RCS with SMS fallback) can similarly provide varying performance.

Each channel-sender combination may be associated with a corresponding engagement metrics. Some channel-sender combinations may not have associated engagement metric. Engagement metrics can include historical data on delivery success rates, read confirmations, response times, and conversion rates for this channel-sender combination. In FIG. 2, channel-sender combination 200A is associated with engagement metrics 180A, channel-sender combination 200B is associated with engagement metrics 180B, channel-sender combination 200C is associated with engagement metrics 180C, but channel-sender combination 200D does not have an associated engagement metrics. Engagement metrics are recipient-specific, so FIG. 2 may be viewed as a recipient-specific view of the channel selection data.

In some embodiments, the channel selection process compares the engagement metric values for all available channel-sender combinations for a particular recipient and selects the channel-sender combination that has the optimal value of the metric. For some channels (e.g., channel 160B), there may be only one sender to consider. Alternatively, when the user engagement metrics are not available (e.g., the channel-sender combination 200D), the channel selection process may use a set of channel selection rules 204, which may specify an order of channels to use. A hybrid approach (using both metrics and rules) may also be used. In some embodiments, there may be cost-driven components in that metric (e.g., a weighted sum of engagement-based metric and a cost-based metric). In some embodiments, there may be cost-ceiling criterion applied to the selected channel. The ceiling may be specific to each user, for a given timeframe, for a particular campaign, and so on. If the cost of the current selection exceeds the ceiling, the selection process may select the next best channel.

This selection and fallback can use the recipient profile database 144, compliance rules database 146, and/or device registration database 148 described in FIG. 1, to help ensure that communication attempts are optimized for delivery success and compliant with applicable regulations. For example, engagement metrics might reveal that a specific recipient consistently engages with authentication messages via push notifications during business hours (channel 160B) but prefers SMS (channel 160A) during evenings, allowing the system to adaptively route messages based on time of day. By evaluating channel options, sender identities, and fallback mechanisms based on engagement metrics, the system can significantly improve message delivery success rates while respecting recipient preferences and regulatory requirements. This architecture can also implement asynchronous processing with operations tracking, where outbound transmissions are validated and queued, then processed in the background. Each operation can be assigned a unique identifier that allows the system to track and report on the aggregated delivery status across multiple recipients, providing visibility into queued, sent, delivered, read, undelivered, and failed message metrics.

In an omnichannel message delivery system, example scenarios can help demonstrate the practical application of the channel selection process illustrated in FIG. 2. For authentication scenarios, the system may evaluate channel-sender combination 200A (channel 160A/SMS with sender 170A/short code) against channel-sender combination 200C (channel 160B/WhatsApp with sender 170C/business account), where engagement metrics 180C indicating higher conversion rates can influence selection of channel-sender combination 200C despite potentially lower delivery rates. For appointment notifications, the system may compare channel-sender combination 200A (channel 160A/SMS with sender 170A/short code) against channel-sender combination 200B (channel 160A/SMS with sender 170B/long code), where engagement metrics 180B showing superior read rates and confirmation responses can justify selection of channel-sender combination 200B. For document delivery notifications, the system can evaluate channel-sender combination 200A (channel 160A/SMS with sender 170A/short code) against channel-sender combination 200C (channel 160B/WhatsApp with sender 170C/business account), where engagement metrics 180C demonstrating superior document access rates may outweigh lower initial open rates, resulting in channel-sender combination 200C being selected as the optimal channel-sender combination 202 for document delivery use cases.

FIG. 3 is a block diagram of an example omni-channel communication component 142, in accordance with some embodiments. Omni-channel communication component 142 includes message queue 306, dequeue engine 302, channel selection module 310, and execution management engine 340. Channel selection module 310 can include an engagement analyzer module 312, channel selection rules engine 314, session context manager 316, compliance rules engine 318, device selection module 320, message transformation engine 322, and batch processing engine 324. In various embodiments, omni-channel communication component 142 can include more or fewer components in different configurations than those depicted in FIG. 3.

Message queue 306 stores incoming messages that need to be processed and delivered to recipients. Dequeue engine 302 retrieves messages from message queue 306 and coordinates with channel selection module 310 to determine the optimal delivery path for each message.

Channel selection module 310 serves as the intelligence system for optimizing message delivery. Engagement analyzer module 312 can process historical engagement data to evaluate the performance of different channel-sender combinations, generating metrics such as delivery rates, read confirmations, and conversion statistics. Channel selection rules engine 314 can apply rules and algorithms to determine the most appropriate channels based on message type, recipient preferences, and/or current conditions.

In some embodiments, session context manager 316 can maintain continuity for ongoing conversations, ensuring that communications within the same thread are delivered through consistent channels when appropriate. In some embodiments, compliance rules engine 318 can help ensure that all communication attempts adhere to regional regulations by identifying the jurisdiction associated with each recipient and filtering available communication channels based on applicable rules.

In some embodiments, device selection module 320 identifies the most appropriate recipient device for delivery, particularly useful for push notifications where recipients may have multiple registered devices. In some embodiments, message transformation engine 322 adapts message content to be compatible with the selected channel's requirements and limitations. In some embodiments, batch processing engine 324 optimizes delivery for bulk messages by grouping similar messages that can be processed through the same channel-sender combinations.

After channel selection module 310 determines the optimal delivery path, execution management engine 340 can implement the selected channel-sender combination by communicating with the appropriate routing providers 150A-N. Execution management engine 340 also handles message delivery tracking and receives feedback from routing providers, which can then be used to update engagement metrics for future optimizations.

This architecture implements the channel selection process described above in reference to FIG. 2, with each component playing a specific role in ensuring optimal message delivery. The dequeue engine 302 works with channel selection module 310 to select optimal channel-sender combination (e.g., 160B, 170B), and implement fallback mechanisms when necessary. Using the submodules within the channel selection module 310, the system can make data-driven decisions at each stage of the delivery process, improving message delivery success rates while respecting recipient preferences and regulatory requirements.

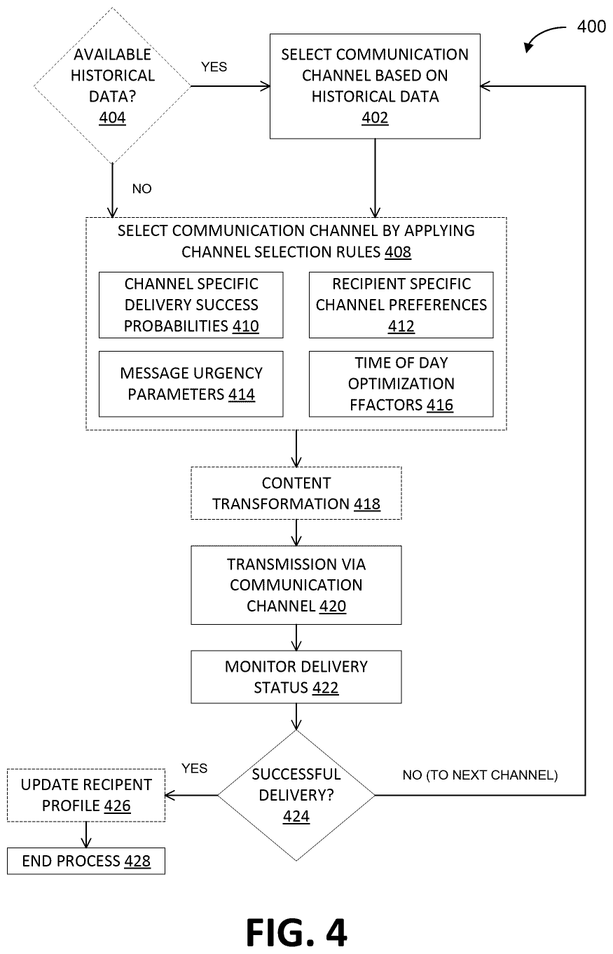

FIG. 4 is a flow diagram of an example method 400 of channel selection, in accordance with aspects of the present disclosure. The method 400 can also be used for implementing fallback channel selection when a primary channel delivery fails. The method 400 may be performed by processing logic that may include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the channel selection module 310 of omni-channel communication component 142 of FIG. 3. Although shown in a particular sequence or order, unless otherwise specified, the order of the operations may be modified. Thus, the illustrated implementations should be understood only as examples, and the illustrated operations may be performed in a different order, while some operations may be performed in parallel. Additionally, one or more operations may be omitted in some embodiments. Thus, not all illustrated operations are required in every embodiment, and other process flows are possible.

In some embodiments, the process begins by selecting 402a communication channel (channel-sender combination described above in reference to FIG. 2; sometimes referred to as a primary communication channel) based on historical data. Such historical data can include delivery success rates, read confirmations, response times, and conversion rates for each channel-sender combination. In some embodiments, the process includes determining if historical data is available 404 and using the historical data for selecting communication channels 402 only when such data is available. Additionally, or alternatively (e.g., when the historical data is unavailable), the system may select a communication channel by applying a set of channel selection rules 408.

Applying the set of channel selection rules 408 can include evaluating a set of factors to determine the most appropriate channel. Channel-specific delivery success probabilities 410 may be analyzed to identify which alternative channels have historically performed well for similar message types. Message urgency parameters 414 may be considered to ensure time-sensitive messages are prioritized appropriately during the fallback selection. Recipient-specific channel preferences 412 may be evaluated to respect individual recipient communication preferences. Time of day optimization factors 416 may also be considered, as recipient responsiveness to different channels often varies based on the time of day (e.g., business versus evening hours). Based on the evaluation of these factors, channel selection 408 can identify the optimal channel.

After selecting the communication channel, content transformation 420 may be implemented to adapt the message format and content to meet the requirements and constraints of the channel. For example, rich media content might need to be simplified when falling back from RCS to SMS. For example, in embodiments where the recipient has a mobile device, the system may automatically attempt delivery via rich messaging channels like RCS first and then fall back to SMS if RCS delivery is not available or fails. This can help ensure that messages are delivered with the highest content fidelity possible while maintaining delivery reliability.

The message (or the transformed message) can then be transmitted 420 via the communication channel. Subsequently, the system can monitor status 422 for delivering the message. At decision point 424, the system can determine if the delivery failure was successful. If the system either receives a message delivery failure report from the routing provider or does not receive a user engagement report from the target application, the system may determine that the delivery was unsuccessful. If no failure is detected (the “YES” path), the system may update recipient profile 426 before the process ends (block 428).

If a delivery failure is detected (the “NO” path), the process may be repeated (sometimes referred to as the fallback), to iteratively select a next communication channel 402. In some embodiments, the system may perform the fallback for a predefined number of fallback channels or until a predetermined number of fallback attempts. Some embodiments may perform the fallback process until a message delivery timeout expiration. This fallback may include selecting an alternate communication channel (e.g., an alternative communication method, such as WhatsApp, Facebook Messenger) and sender (e.g., an appropriate identifier for this alternative channel, such as a business account username), that are different from the primary communication channel (or a previously attempted communication channel). Engagement metrics can inform this fallback selection, tracking metrics, such as delivery latency, open rates, and conversion rates specific to this fallback option. This fallback mechanism can improve message delivery reliability while optimizing for recipient preferences and message urgency. By updating recipient profiles based on delivery outcomes, the system can become increasingly effective at selecting both primary and fallback channels over time.

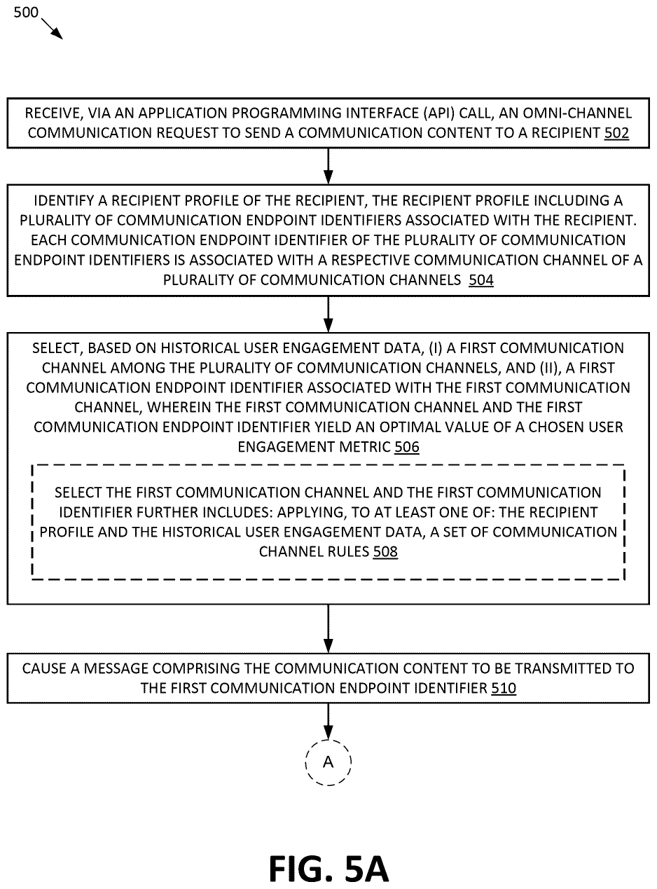

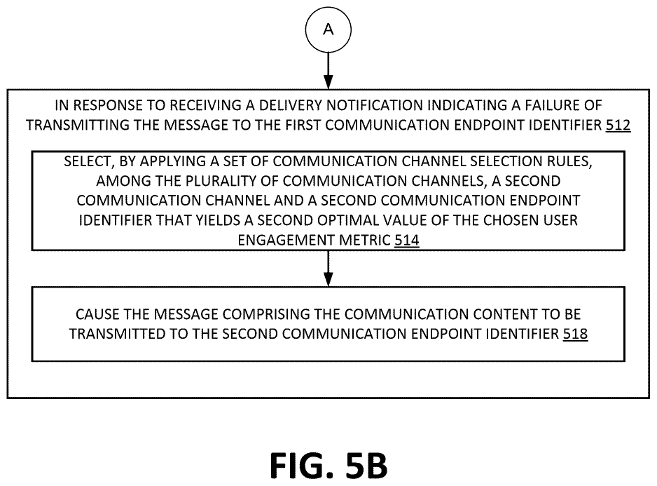

FIGS. 5A and 5B are a flow diagram of an example method 500 of channel selection for communication services platforms, in accordance with an embodiment. Method 500 can be performed by processing logic that can comprise hardware (e.g., circuitry, dedicated logic, etc.), computer-readable instructions such as software or firmware (e.g., run on a general-purpose computing system or a dedicated machine), or a combination thereof. For instance, an example system can include a memory, and a processing device coupled to the memory device to perform operations comprising the blocks of method 500. Method 500 can also be associated with a set of instructions stored on a non-transitory computer-readable medium (e.g., magnetic, or optical disk, etc.). The instructions, when executed by a processing device, can cause the processing device to perform operations comprising the blocks of method 500. In some embodiments, method 500 is performed by customer 132 or communication services platform 130 of FIG. 1. The method may be performed by the channel selection module 310 of omni-channel communication component 142 shown in FIG. 3. In some embodiments, method 500 is performed by computing system 600 of FIG. 6. In some embodiments, blocks depicted in FIGS. 5A and 5B could be performed simultaneously or in a different order than depicted. Various embodiments can include additional blocks not depicted in FIGS. 5A and 5B or a subset of blocks depicted in FIGS. 5A and 5B. For example, block 512 can be absent in some embodiments.

Referring to FIG. 5A, at block 502, the processing logic receives, via an application programming interface (API) call, an omni-channel communication request to send a communication content to a recipient. In some embodiments, the processing logic receives the recipient profile via an API call from the message originating service. The communication content may include various types of information such as one-time passcodes, password resets, account notifications, marketing messages, customer service communications, media content, hyperlinks, or promotions.

At block 504, the processing logic identifies a recipient profile of the recipient, the recipient profile including a plurality of communication endpoint identifiers associated with the recipient. In some embodiments, the processing logic retrieves the recipient profile from the recipient profile database based on the recipient. In some embodiments, the processing logic receives the recipient profile via an API call from the message originating service. Each communication endpoint identifier of the plurality of communication endpoint identifiers is associated with a respective communication channel of a plurality of communication channels. These endpoint identifiers may include phone numbers, email addresses, usernames for messaging platforms, application IDs for push notifications, or other identifiers that enable communication through specific channels.

At block 506, the processing logic selects, based on historical user engagement data, among the plurality of communication channels, a first communication channel and a first communication channel endpoint identifier that yields an optimal value of a chosen user engagement metric. The historical engagement data may comprise message delivery receipts, message read confirmations, message response rates, engagement metrics, or conversion rates. In various embodiments, the historical engagement data can include data characterizing prior communications with the recipient and/or data characterizing prior communications with other recipients, which can be similar to the recipient, by sharing one or more user profile parameters, such as geography, line of business, demographic profile. The processing logic also selects, among the plurality of communication endpoint identifiers associated with the recipient, a first communication endpoint identifier associated with the first communication channel. If the selected channel is a push notification channel, the system may query a device registration database to identify all devices associated with the recipient, determine which devices are currently online, and select a specific device for the outbound transmission based on device activity recency metrics.

In some embodiments, at block 508, the processing logic applies, to at least one of: the recipient profile and the historical user engagement data, channel selection rules for selecting the first communication channel and the first communication channel endpoint identifier. The rules can incorporate factors, such as time of day, geographic location of the recipient, and content type of the communication. For instance, the system may prefer channels where the recipient is currently active, as determined through recent device activity data. The channel selection rules may comprise a multi-dimensional decision matrix that considers channel-specific delivery success probabilities, message urgency parameters, recipient-specific channel preferences, and time-of-day optimization factors. These rules may be applied to the recipient profile and associated historical user engagement data until successful delivery is achieved. For the message urgency parameters, OTP (one-time password) may have the highest priority, promotional messages may have the lowest priority, conversational messages (e.g., when the message to be sent is a part of request-response sequence) may have a medium priority between the above two. For conversational messages, first channel to be attempted may be the same channel that was used for previous messages in the request-response sequence, but if that fails, fallback rules may be applied.

In some embodiments, the channel selection process may retrieve preference data from the recipient profile indicating opt-in or opt-out status for each of the plurality of communication channels, excluding any channels for which the recipient has opted out from consideration. The system may also identify the jurisdiction associated with the recipient, retrieve compliance rules specific to that jurisdiction from a compliance database, and ensure that the selected channel satisfies applicable regulatory requirements.

In some embodiments, the channel selection process may involve maintaining a session context associated with the recipient. If the communication content is part of an ongoing conversation with the recipient, the system may select the first communication channel based at least in part on the communication channel used in previous communications within the session context, ensuring continuity in the conversation. Additionally, the system may classify the communication content into a message type category (e.g., one-time password, account notification, marketing, or customer service) and apply a subset of channel selection rules specifically tailored to that message type.

At block 510, the processing logic causes a message comprising the communication content to be transmitted to the first communication endpoint identifier. Before transmission, the system may transform the communication content into a format optimized for the first communication channel, ensuring proper display and functionality across different platforms.

Referring to FIG. 5B, in some embodiments, at block 512, the processing logic may receive a delivery status notification indicating a failure of transmitting the message to the first communication endpoint identifier. This notification may come from routing providers or other delivery tracking systems within the communication services platform.

In response to receiving this failure notification, at block 514, the processing logic may select, by applying the set of communication channel selection rules, among the plurality of communication channels, a second communication channel and a second communication endpoint identifier that yields a second optimal value of the chosen user engagement metric.

At block 516, the processing logic may cause the message comprising the communication content to be transmitted to the second communication endpoint identifier. As with the previously communications, the content may be transformed to suit the requirements and capabilities of the fallback channel.

After transmission through a communication channel, the system can update the recipient profile based on engagement data collected from the outbound transmission. This continuous feedback loop can enhance the accuracy of future channel selection decisions, allowing the system to adapt to changing recipient behaviors and preferences over time.

In a batch processing scenario, the system can receive a batch API request to send communications to multiple recipients, generate channel engagement scores for each recipient based on their respective channel-specific historical engagement data, and/or concurrently initiate outbound transmissions to the multiple recipients via their respective optimal communication channels. The system can efficiently process different batch sizes based on message complexity, for example supporting larger batches (e.g., up to 10,000 recipients) for identical messages and smaller batches (e.g., up to 1,000 recipients) for personalized messages. For large campaigns, the system can define audience segments based on recipient attributes and target these segments (supporting up to 1 million recipients per segment) while still maintaining personalization capabilities through stored recipient profile attributes.

FIG. 6 is a block diagram illustrating an example computer system 600, in accordance with embodiments of the present disclosure. Computer system 600 may be client devices 120A-N, customer 132, communication services platform 130, or routing providers 150A-N, as described above with reference to FIG. 1. Computer system 600 may operate in the capacity of a server or an endpoint machine in endpoint-server network environment, or as a peer machine in a peer-to-peer (or distributed) network environment. The machine may be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Computer system 600 includes processing device 602 (e.g., one or more processors or cores), main memory 604 (e.g., read-only memory (ROM), flash memory, dynamic random access memory (DRAM) such as synchronous DRAM (SDRAM), double data rate (DDR SDRAM), or DRAM (RDRAM), etc.), static memory 606 (e.g., flash memory, static random access memory (SRAM), etc.), and data storage device 608, which communicate with each other via bus 610.

Processing device 602 represents one or more general-purpose processing devices such as a microprocessor, central processing unit, or the like. More particularly, processing device 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 is configured to execute instructions 612 (e.g., for storing contextual data with context schemas) for performing the operations discussed herein.

Computer system 600 may further include network interface device 614. Computer system 600 also may include display device 616 (e.g., a liquid crystal display (LCD) or a cathode ray tube (CRT)), alphanumeric input device 618 (e.g., a keyboard, and alphanumeric keyboard, a motion sensing input device, touch screen), cursor control device 620 (e.g., a mouse), and signal generation device 622 (e.g., a speaker). In some embodiments, computer system 600 may not include display device 616, alphanumeric input device 618, and/or cursor control device 620 (e.g., in a headless configuration).

Data storage device 608 may include a non-transitory machine-readable storage medium 624 (also computer-readable storage medium) on which is stored one or more sets of instructions 612 (e.g., for storing contextual data with context schemas) embodying any one or more of the methodologies or functions described herein. Instructions 612 may also reside, completely or at least partially, within main memory 604 or within the processing device 602 during execution thereof by computer system 600, main memory 604 and processing device 602 also constituting machine-readable storage media. Instructions 612 may further be transmitted or received over network 626 via network interface device 614.

In some embodiments, instructions 612 include instructions for storing contextual data with context schemas, as described herein. While computer-readable storage medium 624 (machine-readable storage medium) is shown in an exemplary embodiment to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the disclosure may be practiced without these specific details. In some instances, well-known structures and devices are shown in block diagram form, rather than in detail, to avoid obscuring the disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It may be borne in mind, however, that all of these and similar terms are to be associated with the appropriate physical quantities and are merely convenient labels applied to these quantities. Unless specifically stated otherwise, it is appreciated that throughout the description, discussions utilizing terms such as “authenticating”, “providing”, “receiving”, “identifying”, “determining”, “sending”, “enabling” or the like, refer to the actions and processes of a computer system, or similar electronic computing device, that manipulates and transforms data represented as physical (e.g., electronic) quantities within the computer system memories or registers into other data similarly represented as physical quantities within the computer system memories or registers or other such information storage, transmission or display devices.

The disclosure also relates to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including a floppy disk, an optical disk, a compact disc read-only memory (CD-ROM), a magnetic-optical disk, a read-only memory (ROM), a random access memory (RAM), an erasable programmable read-only memory (EPROM), an electrically erasable programmable read-only memory (EEPROM), a magnetic or optical card, or any type of media suitable for storing electronic instructions.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims may generally be construed to mean “one or more” unless specified otherwise or clear from context to be directed to a singular form. Moreover, use of the term “an implementation” or “one implementation” or “an embodiment” or “one embodiment” throughout is not intended to mean the same implementation or embodiment unless described as such. The terms “first,” “second,” “third,” “fourth,” etc. as used herein are meant as labels to distinguish among different elements and may not necessarily have an ordinal meaning according to their numerical designation.

For simplicity of explanation, methods herein are depicted and described as a series of acts or operations. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In additional embodiments, one or more processing devices for performing the operations of the above-described embodiments are disclosed. Additionally, in embodiments of the disclosure, a non-transitory computer-readable storage medium stores instructions for performing the operations of the described embodiments. Also in other embodiments, systems for performing the operations of the described embodiments are also disclosed.

It is to be understood that the above description is intended to be illustrative, and not restrictive. Other embodiments will be apparent to those of skill in the art upon reading and understanding the above description. The scope of the disclosure may, therefore, be determined with reference to the appended claims, along with the full scope of equivalents to which such claims are entitled.

What is claimed is:

1. A method, comprising:
receiving, via an application programming interface (API) call, an omni-channel communication request to send a communication content to a recipient;
identifying a recipient profile of the recipient, the recipient profile including a plurality of communication endpoint identifiers associated with the recipient, wherein each communication endpoint identifier of the plurality of communication endpoint identifiers is associated with a respective communication channel of a plurality of communication channels;
selecting, based on historical user engagement data, (i) a first communication channel among the plurality of communication channels, and (ii) a first communication endpoint identifier associated with the first communication channel, wherein selection of the first communication channel and the first communication endpoint identifier is predicted to yield an optimal value of a chosen user engagement metric; and
causing a message comprising the communication content to be transmitted to the first communication endpoint identifier.

2. The method of claim 1, wherein selecting the first communication channel and the first communication endpoint identifier further comprises: applying, to at least one of: the recipient profile and the historical user engagement data, a set of communication channel selection rules.

3. The method of claim 1, further comprising:
receiving a delivery status notification indicating a failure of transmitting the message to the first communication endpoint identifier; and
in response to receiving the delivery status notification:
selecting, by applying a set of communication channel selection rules, among the plurality of communication channels, a second communication channel and a second communication endpoint identifier associated with the second communication channel that yields a second optimal value of the chosen user engagement metric; and
causing the message comprising the communication content to be transmitted to the second communication endpoint identifier.

4. The method of claim 1, wherein selecting the first communication channel and the first communication endpoint identifier further comprises: applying, to at least one of: the recipient profile and the historical user engagement data, a set of communication channel selection rules, wherein the set of communication channel selection rules comprises a multi-dimensional decision matrix comprising:
channel-specific delivery success probabilities;
message urgency parameters;
recipient-specific channel preferences; and
time-of-day optimization factors.

5. The method of claim 1, wherein selecting the first communication channel and the first communication endpoint identifier further comprises: applying, to at least one of: the recipient profile and the historical user engagement data, a set of communication channel selection rules, wherein applying the set of communication channel selection rules comprises selecting the first communication channel based on time of day, geographic location of the recipient, and content type of the communication content.

6. The method of claim 1, wherein selecting the first communication channel and the first communication endpoint identifier further comprises: applying, to at least one of: the recipient profile and the historical user engagement data, a set of communication channel selection rules, wherein applying the set of communication channel selection rules comprises preferring communication channels where the recipient is currently active.

7. The method of claim 1, wherein selecting the first communication channel and the first communication endpoint identifier further comprises: applying, to at least one of: the recipient profile and the historical user engagement data, a set of communication channel selection rules, wherein applying the set of communication channel selection rules comprises:
retrieving preference data from the recipient profile indicating opt-in or opt-out status for each of the plurality of communication channels; and
excluding communication channels for which the recipient has opted out from consideration during the selection.

8. The method of claim 1, wherein selecting the first communication channel and the first communication endpoint identifier further comprises: applying, to at least one of: the recipient profile and the historical user engagement data, a set of communication channel selection rules, wherein applying the set of communication channel selection rules comprises:
maintaining a session context associated with the recipient; and
in accordance with a determination that the communication content is part of an ongoing conversation with the recipient:
selecting the first communication channel from the plurality of communication channels based at least in part on a communication channel used in previous communications within the session context.

9. The method of claim 1, wherein selecting the first communication channel and the first communication endpoint identifier further comprises: applying, to at least one of: the recipient profile and the historical user engagement data, a set of communication channel selection rules, wherein applying the set of communication channel selection rules comprises:
retrieving a communication history including delivery receipt data for previous outbound transmissions to the recipient; and
selecting the first communication channel from the plurality of communication channels further based on analyzing the delivery receipt data to identify patterns in successful delivery attempts.

10. The method of claim 1, wherein selecting the first communication channel and the first communication endpoint identifier further comprises: applying, to at least one of: the recipient profile and the historical user engagement data, a set of communication channel selection rules, wherein applying the set of communication channel selection rules comprises:
classifying the communication content into a message type category from among a plurality of predefined categories including at least one-time password, account notification, marketing, and customer service; and
applying a subset of the set of communication channel selection rules that correspond to the message type category.

11. The method of claim 1, wherein causing the message comprising the communication content to be transmitted to the first communication endpoint identifier further comprises:
transforming the communication content into a format optimized for the first communication channel.

12. The method of claim 1, wherein the historical user engagement data comprises at least one of: message delivery receipts, message read confirmations, message response rates, engagement metrics, or conversion rates.

13. The method of claim 1, further comprising:
receiving a batch API request to send communications to multiple recipients;
generating channel engagement scores for each recipient based on their respective channel-specific historical engagement data; and
concurrently initiating outbound transmissions to the multiple recipients via their respective optimal communication channels.

14. A system comprising:
a memory device; and
a processing device coupled to the memory device, the processing device to perform operations comprising:
receiving, via an application programming interface (API) call, an omni-channel communication request to send a communication content to a recipient;
identifying a recipient profile of the recipient, the recipient profile including a plurality of communication endpoint identifiers associated with the recipient, wherein each communication endpoint identifier of the plurality of communication endpoint identifiers is associated with a respective communication channel of a plurality of communication channels;
selecting, based on historical user engagement data, (i) a first communication channel among the plurality of communication channels, and (ii) a first communication endpoint identifier associated with the first communication channel, wherein selection of the first communication channel and the first communication endpoint identifier yield is predicted to yield an optimal value of a chosen user engagement metric; and
causing a message comprising the communication content to be transmitted to the first communication endpoint identifier.

15. The system of claim 14, wherein selecting the first communication channel and the first communication endpoint identifier further comprises: applying, to at least one of: the recipient profile and the historical user engagement data, a set of communication channel selection rules.

16. The system of claim 14, wherein the operations further comprise:
receiving a delivery status notification indicating a failure of transmitting the message to the first communication endpoint identifier; and
in response to receiving the delivery status notification:
selecting, by applying a set of communication channel selection rules, among the plurality of communication channels, a second communication channel and a second communication endpoint identifier associated with the second communication channel that yields a second optimal value of the chosen user engagement metric; and
causing the message comprising the communication content to be transmitted to the second communication endpoint identifier.

17. The system of claim 14, wherein selecting the first communication channel and the first communication endpoint identifier further comprises: applying, to at least one of: the recipient profile and the historical user engagement data, a set of communication channel selection rules, wherein the set of communication channel selection rules comprises a multi-dimensional decision matrix comprising:
channel-specific delivery success probabilities;
message urgency parameters;
recipient-specific channel preferences; and
time-of-day optimization factors.

18. The system of claim 14, wherein selecting the first communication channel and the first communication endpoint identifier further comprises: applying, to at least one of: the recipient profile and the historical user engagement data, a set of communication channel selection rules, wherein applying the set of communication channel selection rules comprises selecting the first communication channel based on time of day, geographic location of the recipient, and content type of the communication content.

19. The system of claim 14, wherein selecting the first communication channel and the first communication endpoint identifier further comprises: applying, to at least one of: the recipient profile and the historical user engagement data, a set of communication channel selection rules, wherein applying the set of communication channel selection rules comprises preferring communication channels where the recipient is currently active.

20. A non-transitory computer-readable medium comprising instructions that, when executed by a processing device, cause the processing device to perform operations comprising:
receiving, via an application programming interface (API) call, an omni-channel communication request to send a communication content to a recipient;
identifying a recipient profile of the recipient, the recipient profile including a plurality of communication endpoint identifiers associated with the recipient, wherein each communication endpoint identifier of the plurality of communication endpoint identifiers is associated with a respective communication channel of a plurality of communication channels;
selecting, based on historical user engagement data, (i) a first communication channel among the plurality of communication channels, and (ii) a first communication endpoint identifier associated with the first communication channel, wherein selection of the first communication channel and the first communication endpoint identifier is predicted to yield an optimal value of a chosen user engagement metric; and
causing a message comprising the communication content to be transmitted to the first communication endpoint identifier.
